(19) United States
(12) Patent Application Publication
(10) Pub. No.: US 2014/0291014 A1
(43) Pub. Date: Oct. 2, 2014

(54) PROTECTION MEMBER FOR CABLE

(71) Applicants: HONG FU JIN PRECISION INDUSTRY (ShenZhen ) CO., LTD., (US); HON HAI PRECISION INDUSTRY CO., LTD, New Taipei (TW)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD ., Shenzhen (CN)

(21) Appl. No.: 13/859,737

(22) Filed: Apr. 10, 2013

(30) Foreign Application Priority Data
Mar. 27, 2013 (CN) 201310101589.X

(51) Int. Cl. H02G 3/22

(52) U.S. Cl. CPC H02G 3/22
USPC 174/650

(57) ABSTRACT

A protection member for protecting cables extending through an installing hole of a board includes a plate defining a through hole, and a flange portion extending out from a sidewall bounding the through hole. A number of resilient portions are extended from the flange portion. The flange portion is extended through the installing hole. The plate and the resilient portions are abutted against opposite sides of the board.

### BACKGROUND

1. Technical Field

The present disclosure relates to a member for preventing abrasion of cables.

2. Description of Related Art

In a sever, a number of through holes is defined in the installation boards to allow cables to extend through. However, many of the installation boards are thin, and the cables are easily abraded by sidewalls bounding the through holes. One solution has been to install flexible grommets in the through holes. However, the grommets, due to their flexibility, are not easily engaged on all sides of the sidewalls, and installation of grommets is time consuming.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a protection member, together with a board.

FIG. 2 is an assembled, isometric view of the protection member and the board of FIG. 1 and a plurality of cables.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

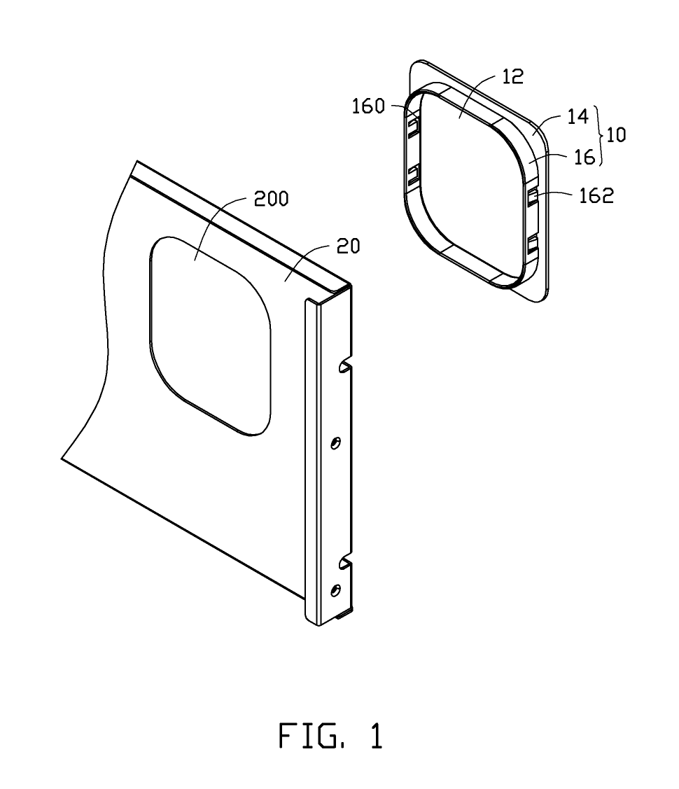

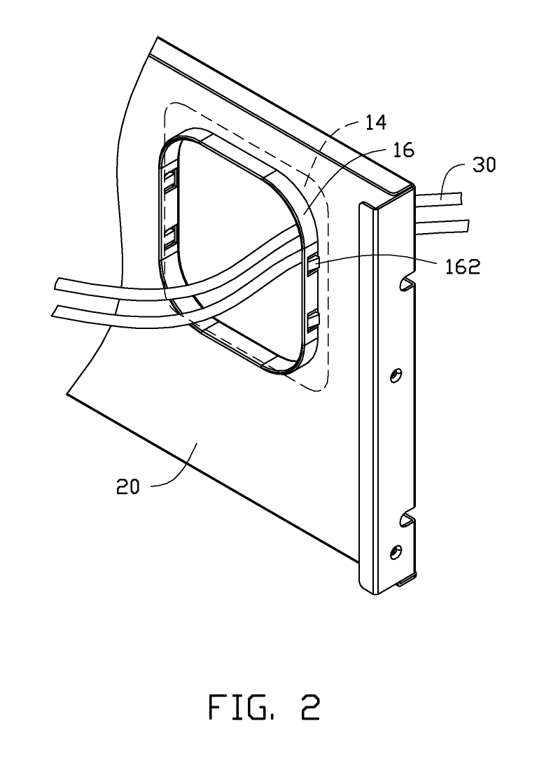

Referring to FIGS. 1 and 2, an exemplary embodiment of a protection member 10 is provided for protecting cables 30. The protection member 10 is mounted to a board 20 defining an installing hole 200 through which the cables 30 are extended.

The protection member 10 includes a plate 14 defining a through hole 12 corresponding to the installing hole 200, and a flange portion 16 extending out from sidewalls bounding the through hole 12. The flange portion 16 is substantially perpendicular to the plate 14. Two cutouts 160 are defined in each of opposite two sides of the flange portion 16. A resilient portion 162 is connected to an end wall bounding each cutout 160 and away from the plate 12. The resilient portions 162 are spaced from the plate 14. A distal end of each resilient portion 162 adjacent to the plate 14 protrudes out from the flange portion 16.

In assembly, the flange portion 16 is extended through the installing hole 200. The resilient portions 162 are deformed to withdraw into the corresponding cutouts 160, until the plate 14 abuts against a side of the board 20. The distal ends of the resilient portions 162 are then extended out of the corresponding cutouts 160 to abut against the other side of the board 20 opposite to the plate 14.

The cables 30 are spaced from sidewall bounding the installing hole 200 by the flange portion 16 which is wider than the sidewall, therefore, the cables 30 will not be abraded by the sidewall.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A protection member for protecting cables extending through an installing hole of a board, the protection member comprising:
a plate defining a through hole; and
a flange portion extending out from a sidewall bounding the through hole, a plurality of resilient portions extending from the flange portion,
wherein, when in use, the plate abuts against a first side of the board and the flange portion extends through the installing hole, and the resilient portions abut against an second side of the board opposite to the first side.

2. The protection member of claim 1, wherein the flange portion defines a plurality of cutouts in opposite two sides of the flange portion, each resilient portion is connected to an end wall bounding one of the cutouts and away from the plate.
